(19) United States
(12) Patent Application Publication
(10) Pub. No.: US 2015/0351394 A1
(43) Pub. Date: Dec. 10, 2015

(54) BACTERICIDAL COMPOSITION CONTAINING FLUAZINAM

(71) Applicant: Shenzhen Noposion Agrochemicals Co., Ltd., Shenzhen (CN)

(72) Inventors: Chenglai Zhang, Shenzhen (CN); Mingzhang Cao, Shenzhen (CN); Huadong Zhang, Shenzhen (CN); Xinjun Wang, Shenzhen (CN); Guangze Li, Shenzhen (CN); Jian Kong, Shenzhen (CN)

(21) Appl. No.: 14/296,573

(22) Filed: Jun. 5, 2014

(51) Int. Cl. A01N 43/40; A01N 31/16

(52) U.S. Cl. CPC A01N 43/40; A01N 31/16

(57) ABSTRACT

The present invention discloses a bactericidal composition containing fluazinam. Active ingredients of the bactericidal composition are formed by fluazinam (A) and eugenol (B). The weight ratio of A to that of B is from 1:50 to 100:1. The composition has a significant synergistic effect and a high control effect. The composition is adapted for preventing and curing various diseases of fruits and vegetables, and is particularly adapted for preventing and curing pepper phytophthora blight.

### CROSS-REFERENCE TO RELATED APPLICATIONS

This is a continuation of International Application PCT/CN2012/085699, with an international filing date Nov. 30, 2012, which has a priority date of Dec. 3, 2011, claiming benefits of China application 201110407144.5.

### BACKGROUND OF THE INVENTION

1. Field of the Invention

The present invention relates to bactericidal compositions and, more particularly to a bactericidal composition containing fluazinam.

2. Description of Related Art

Pepper phytophthora blight is caused by infestation from mastigomycotina pepper phytophthora capsici. Pathogenic bacteria hibernate in the soil or plant debris in an oospore form and propagate via the wind, rainwater, irrigation and other agricultural activities. After the onset of disease, new sporangium is generated after onset and forms zoospore to cause secondary infection.

The pepper phytophthora blight commonly damages leaves, fruits and stems, especially readily happens to the stem base. The blight occurring in a seedling stage initially infects almost the stem base, where soft rot like water blots and dark-green scabs appears, and then lodging happens to part above the infested base. The blight spreads more rapidly at air humidity above 90%. Continuous cropping, low-lying land, poor drainage, excessive nitrogen fertilizer, large sowing density and weak plant contribute to occurrence and propagation of the blight.

Fluazinam is a kind of 2,6-dinitro aniline compounds as a broad spectrum protective fungicide, and has an excellent effect on pathogenic bacteria of Alternaria, Botrytis, Phytophthora, Plasmopara, Sclerotinia and Venturia. Common name in English is called as Fluazinam, chemical name is 3-chloro-N-(3-chloro-5-trifluoromethyl-2-pyridyl)-α,α,α-trifluor-2,6-dinitro-p-toluidine and molecule formula is C₁₃H₄Cl₂F₆N₄O₄. Fluazinam is able to prevent and cure specific diseases including cucumber pepper phytophthora blight, downy mildew, anthracnose, tomato late blight, apple scab, leaf spot disease, pear black spot, rust disease, rice blast, sheath blight, crown rust of oat, grape pepper phytophthora blight, downy mildew, citrus scab, pepper blight, potato late blight, greensward spot disease, etc. Fluazinam has a good effect against plant pathogenic fungi of botrytis cinerea which is resistance to bactericides of benzimidazoles and dicarboxyl imides. Fluazinam has a rain erosion resistance and a long effective period.

Indoor bioassays and field effective experiments show that fluazinam has a good control effect to the pepper blight.

However, at present, cost of both manufacture and application of fluazinam is higher. Furthermore, an assessment study on resistance risk shows that long-term exclusive use of the pesticide brings about a great resistance risk. One of effective approaches to solve problem of cost and resistance in exclusive use is to synergize fluazinam with other pesticide effective ingredients. Mixing of various pesticide effective ingredients with different chemical structures generally produces three kinds of effects, i.e., additive action, synergized action and antagonistic action. A formulation with a good synergism is able to improve practical control effect, reduce consumption of pesticides, and contributes to postpone occurrence of pesticide resistance of pathogenic bacteria. This becomes an important approach for comprehensive prevention and cure.

At present, there has no report about preventing and curing diseases by admixing fluazinam and eugenol at home and abroad, as well as there is no any relevant experiments, manufacture and application of fluazinam.

### SUMMARY OF THE INVENTION

Therefore, a bactericidal composition containing fluazinam is provided, which has a significant synergism, a good control effect to pepper phytophthora blight, a low cost and a low resistance risk.

An application of the bactericidal composition is also provided.

A bactericidal composition containing fluazinam includes effective ingredients of fluazinam and eugenol. Weight ratio of fluazinam to eugenol is from 1:50 to 100:1.

The composition has the following advantages: 1. significant synergism and improved control effect compared to single pesticide, 2. fewer consumption of the effective ingredients used in the fields due to improved effect, low cost of production and use, decreased reminder of pesticide and environmental pollution, 3. The composition is made of various effective ingredients with different action mechanism so as to increase action sites and to be benefit for overcoming and proponing formation of resistance pesticide of pathogenic bacteria.

### DETAILED DESCRIPTION OF THE INVENTION

The combination of different types of pesticide active ingredients has become one of effective means for solving the problem of cost and resistance of single pesticide in use. The combination of different types of pesticide active ingredients generally forms three types of effect, namely, additive action, synergized action and antagonistic action. However, it cannot be predicted which effect of the admixture will bight about. The effect of the admixture is just determined by a large number of experiments. A good synergistic formulation can improve practical control effect, reduce use consumption of the pesticide and propone formation of pesticide resistance, and is thus an important means for scientifically preventing and curing pests and blights.

The composition of the present invention has a significant synergistic action, not merely a simple addition of effects of the two pesticide agents. This is distinctly shown in the experiment results of the following bioassay examples, which are only exemplary but not limitation to the present invention.

Inventors unexpectedly discovered that admixture of fluazinam with eugenol in a certain proportion produces a significant synergistic action to the diseases, for example the pepper phytophthora blight, by a large number of indoor bioassays and field effective experiments.

Accordingly, in accordance with an embodiment of the present invention, a bactericidal composition containing fluazinam is provided, which includes effective ingredients of fluazinam and eugenol. Weight ratio of fluazinam to eugenol is from 1:50 to 100:1. The weight ratio of fluazinam to eugenol is preferably from 1:30 to 20:1.

The eugenol has an English name, eugenol, a chemical name of 4-allyl-2-methoxy-phenol, a molecule formula of C₁₀H₁₂O₂ and a molecule weight of 164.20. The eugenol has a low toxicity and is safe to humanbeing, animal and environment, and can effectively prevent and cure the pepper phytophthora blight.

The fluazinam and eugenol may be obtained from a variety of commercial channels.

The effective ingredients of the bactericidal composition can be processed into any types of formulations allowed in agriculture, in accordance with different cooperative assistants and fillers. Preferable types of formulations include suspension type, aqueous emulsion type, wettable powder type and water dispersible granule type. Thus, the composition further comprises assistants and fillers used in the processing of the active ingredients.

In the bactericidal composition of the present invention, total weight percentage of the effective ingredients of A and B is preferably from 5% to 80%.

The formulation of the above bactericidal composition includes not only the effective ingredients of A and B, but also assistant and other substances helpful to exert efficacy of the effective ingredients. The aqueous emulsion type includes organic solvent, dispersant, emulsifier and water. The suspension type includes water, dispersant, thickener, antifreezer and humectant. The wettable powder type includes humectant, dispersant, and filler. The water dispersible granule type includes dispersant, disintegrating agent, filler and humectant. Those described above are ingredients usually used or allowable in pesticide formulations without special restriction. The specific ingredient election and usage amount are determined according to requirements of formulations by ordinary experiments.

For example, the organic solvent may be selected from the group consisting of: isopropanol, dimethylbenzene, N,N-dimethyl formamide, cyclohexanone, methylbenzene, dimethyl sulfoxide, methanol, alcohol, trimethyl-2-cyclohexen-1-one, N-octyl pyrrolidone, N-methyl pyrrolidone, propanol, butanol, ethanediol, diethylene glycol, ethylene glycol methyl ether, butylether, acetic ether and vegetable oil.

The dispersant may be selected from the group consisting of: sodium lignosulphonate, calcium lignosulphonate, nekal, calcium dodecylbenzene sulfonate, polycarboxylate, calcium alkylaromatic sulfonate, alkylphenol ethoxylates, aliphatic amine polyoxyethylene ether, polyoxyethylene fatty acid ester and glycerin fatty acid ester ethoxylates.

The emulsifier may be selected from the group consisting of: pesticide emulsifier No. 600 (phenyl phenol polyoxyethylene ether), pesticide emulsifier No. 1601 (phenylethyl phenol polyoxyethylene polypropylene ether), pesticide emulsifier No. 500 (calcium alkylbenzene sulfonate), OP series phosphate (phosphate polyoxyethylene nonyl phenol ethers), No. 600 phosphate (phenyl phenol polyoxyethylene ether phosphate), styrene polyoxyethylene ether ammonium sulfate, magnesium alkyl diphenyl ether disulfonate, triethanolamine salt, pesticide emulsifier No. 400 (phenyl dimethylphenol polyoxyethylene ether), pesticide emulsifier No. 700 (alkyl phenolic resin polyoxyethylene ether), ning-emulsifier No. 36 (phenylethyl phenol formaldehyde resin polyoxyethylene ether), pesticide emulsifier No. 1600 (phenylethyl phenol polyoxyethylene polypropylene ether), epoxyethane propylene oxide block copolymer, OP series (polyoxyethylene nonyl phenol ether), pesticide emulsifier No. 33 (alkylaryl polyoxypropylene polyoxyethylene ether), pesticide emulsifier No. 34 (alkylaryl polyoxyethylene polyoxypropylene ether), Span series (sorbitan monostearates), Tween series (polyoxyethylene sorbitan fatty acid esters) and AEO series (fatty alcohol polyoxyethylene ether).

The antifreezer may be selected from the group consisting of: propanetriol, carbamide, ethanediol and propanediol.

The humectant may be selected from the group consisting of: sodium naphthalenesulfonate formaldehyde condensates, sodium dodecyl sulfate, sodium alkylnaphthalene sulphonate, calcium alkylbenzene sulfonate, sasangua cake, shikakai powder, silkworm excrement, sapindus power, sodium lauryl sulfate, washing powder and nekal powder.

The disintegrating agent may be selected from the group consisting of: ammonia sulfate, carbamide, bentonite, aluminium chloride, citric acid, succinic acid and sodium bicarbonate.

The thickener may be selected from the group consisting of: xanthan gum, hydroxy methyl cellulose, methylcellulose, magnesium aluminum silicate and polyvinyl alcohol.

The filler may be selected from the group consisting of: white carbon black, clay, light calcium carbonate, speckstone, montmorillonite, palygorskite, pumice, brickbat, sepiolite, bentonite, non-adsorptive calcareous soil and sand.

The composition described in the embodiment of the present invention could be in a form of finished preparations, namely, all ingredients of the composition are preliminarily admixed before use. Besides, the ingredients of the composition may be provided in a separated form and are directly admixed in a barrel or jug and then are diluted to required concentration before use.

The bactericidal composition of the embodiment of the present invention may be used for preventing and curing a variety of plant diseases, preferably for the pepper phytophthora blight. The composition of the embodiment of the present invention could be applied according to a common means of, for example, irrigating, squirting, spraying, sprinkling, scattering and fuming. The amount of application varies according to changes of air conditions or status of crops.

### Bioassay Example 1

### Determination of Indoor Toxicities of the Composition to Pepper Phytophthora capsici

The pepper phytophthora capsici is acted as test object.

Test methods: referring to the “Republic of China agricultural industry standard NY/T1156.11-2008”, selecting growing consensus potted pepper seedlings, selecting five pots per test object with respective number for use, spraying five milliliters for each pot by a Potter spray tower in a pressure of 50 PSI. The test results are shown in Tables 1 and 2 and each test pesticide is provided with five concentration gradients. After 24 hours, five millimeters pepper phytophthora capsici mycelium blocks are inoculated into the objects. Pepper seedlings with an equal amount of water spraying are selected as the blank control. After inoculation, pepper seedlings are shifted into light moisturizer cabinets for culture. After 8 days, in accordance with grading standards of incidence of pepper phytophthora blights, the disease indexes are surveyed and the control effects are calculated.

Capsici disease classification criteria:

0 level: no lesion on the leaves;

1 level: lesion area of the total leaf area is 5% or less;

3 level: lesion area of the total leaf area is from 6% to 10%;

5 level: lesion area of the total leaf area is from 11% to 25%;

7 level: lesion area of the total leaf area is from 25% to 50%;

9 level: lesion area of the total leaf area is 50% or more.

Disease index=[Σ(leaf quantity in each level×respective level number)×100]/(Total quantity of tested leaves×9).

Control effect (%)=[(blank disease index−treated disease index)]×100]/blank disease index.

Expected effect of a mixture of the active ingredients (i.e., control effect in theory, %) is determined by using Colby's formula and is compared with observed effect:

Colby formula: E=X+Y−X*Y/100

E: expected effect of the composition provided that active ingredient A thereof is in a concentration of a value, and active ingredient B is in a concentration of b value.

X: expected effect provided that usage dose of the active ingredient A is a value.

Y: expected effect provided that usage dose of the active ingredient B is b value.

It is testified that the mixture has a synergistic effect when the actual control effect observed exceeds the expected control effect.

Toxicity test results are shown in Table 1 and Table 2.

TABLE 1
Experiment results of single active compounds
to potted pepper phytophthora blights

| | | Concentration of active | Actual |
|---|---|---|---|
| Number of | Active | compounds in spraying droplet | effect |
| treatment | compounds | (ppm) | (%) |
| 1 | Clean water | — | — |
| 2-1 | Fluazinam | 100 | 87.1 |
| 2-2 | Fluazinam | 50 | 71.4 |
| 2-3 | Fluazinam | 20 | 52.9 |
| 2-4 | Fluazinam | 10 | 31.2 |
| 2-5 | Fluazinam | 1 | 11.4 |
| 3-1 | Eugenol | 100 | 79.5 |
| 3-2 | Eugenol | 50 | 63.8 |
| 3-3 | Eugenol | 30 | 46.3 |
| 3-4 | Eugenol | 10 | 17.6 |
| 3-5 | Eugenol | 1 | 6.2 |

TABLE 2
Experiment results of fluazinam synergized with
eugenol to potted pepper phytophthora blights

| | Concentration of active | Actual | Expected |
|---|---|---|---|
| Number of | ingredients in the mixture | effect | effect |
| synergy | (ppm:ppm) | (%) | (%) |
| 1 | Fluazinam 100:Eugenol 1 | 93.4 | 87.9 |
| 2 | Fluazinam 50:Eugenol 1 | 80.6 | 73.2 |
| 3 | Fluazinam 20:Eugenol 1 | 64.7 | 55.8 |
| 4 | Fluazinam 10:Eugenol 1 | 46.3 | 35.5 |
| 5 | Fluazinam 10:Eugenol 10 | 52.1 | 43.3 |
| 6 | Fluazinam 1:Eugenol 10 | 35.8 | 26.9 |
| 7 | Fluazinam 1:Eugenol 30 | 61.2 | 52.4 |
| 8 | Fluazinam 1:Eugenol 50 | 76.5 | 67.9 |
| 9 | Fluazinam 1:Eugenol 100 | 79.6 | 81.8 |

The experiment results show that fluazinam synergized with eugenol within a certain proportion against the pepper blight produces a synergistic effect.

Objects, technical solutions and advantages of the embodiments of the present invention will be explained below in detail with reference to the accompanying formulation Examples. However, it is to be appreciated that the following description of the embodiment(s) is merely exemplary in nature and is no way intended to limit the invention, its application, or uses. It should be noted that, any changes, equivalent replacements and improvements within the spirit and principle of the present invention should be included in the scope of the present invention. Accordingly, the scope of protection of the present invention is claimed within scope of the appended claims.

Examples of Suspensions

The active ingredients, dispersant, defoamer, thickeners, water and other ingredients are uniformly mixed in a formulation proportion, and then a semi-finished product is obtained after sanding or high shear. After analysis, the semi-finished product is uniformly mixed with additional water and then is filtered to obtain the suspension.

### Formulation Example 1

### 15.3% Fluazinam•Eugenol suspension

Fluazinam 0.3%, eugenol 15%, polyoxyethylene nonyl phenol ether 8% (emulsifier), propylene glycol 2% (co-solvent), xanthan gum 1% (thickener), organosilicone 2% (defoamer), water of the complement to 100%.

### Formulation Example 2

### 30.3% Fluazinam•Eugenol suspension

Fluazinam 30%, eugenol 0.3%, polyoxyethylene nonyl phenol ether 8% (emulsifier), propylene glycol 2% (co-solvent), xanthan gum 1% (thickener), organosilicone 2% (defoamer), water of the complement to 100%.

### Formulation Example 3

### 30% Fluazinam•Eugenol suspension

Fluazinam 15%, eugenol 15%, polyoxyethylene nonyl phenol ether 8% (emulsifier), propylene glycol 2% (co-solvent), xanthan gum 1% (thickener), organosilicone 2% (defoamer), water of the complement to 100%.

### Formulation Example 4

### 21% Fluazinam•Eugenol suspension

Fluazinam 20%, eugenol 1%, polyoxyethylene nonyl phenol ether 8% (emulsifier), propylene glycol 2% (co-solvent), xanthan gum 1% (thickener), organosilicone 2% (defoamer), water of the complement to 100%.

### Formulation Example 5

### 6.2% Fluazinam•Eugenol suspension

Fluazinam 0.2%, eugenol 6%, polyoxyethylene nonyl phenol ether 8% (emulsifier), propylene glycol 2% (co-solvent), xanthan gum 1% (thickener), organosilicone 2% (defoamer), water of the complement to 100%.

### Formulation Example 6

### 22% Fluazinam•Eugenol suspension

Fluazinam 20%, eugenol 2%, polyoxyethylene nonyl phenol ether 8% (emulsifier), propylene glycol 2% (co-solvent), xanthan gum 1% (thickener), organosilicone 2% (defoamer), water of the complement to 100%.

Examples of Aqueous Emulsions

The active ingredients are dissolved into a solvent and a co-solvent according to respective formulation ratios, and then an oil phase is obtained after uniformly mixing with surfactant. Other water-soluble ingredients are mixed with water to obtain aqueous phase. The aqueous phase is added into the oil phase whilst is stirred to obtain theaqueous emulsion.

### Formulation Example 7

### 5% Fluazinam•Eugenol Aqueous Emulsion

Fluazinam 4.7%, eugenol 3%, DMF (solvent) 5%, cyclohexanol (solvent) 10% glycerol (antifreeze) 5%, phenethyl phenol polyoxyethylene ether (emulsifier)) 10%, calcium dodecylbenzene sulfonate (humectant) 5%, water of the complement to 100%.

### Formulation Example 8

### 10.5% Fluazinam•Eugenol Aqueous Emulsion

Fluazinam 10%, eugenol 0.5%, turpentine oil (vegetable oil solvent) 5%, Jatropha oil (vegetable oil solvent) 10%, glycerol (antifreeze) 5%, phenethyl phenol polyoxyethylene ether (emulsifier) 10%, calcium dodecylbenzene sulfonate (humectant) 5%, water of the complement to 100%.

Examples of Water Dispersible Granules

The pesticide active ingredients, additives and fillers are mixed in given proportion and are crushed by the jet mill, then admixed with water of 15-20% weight. The water dispersible granule product is obtained by kneading, granulating, drying and sieving. Major equipments: mixer, jet mill, kneader, extrusion granulator, drying equipment (drying room or fluid bed).

### Formulation Example 9

### 80% Fluazinam•Eugenol Water Dispersible Granules

Fluazinam 78%, eugenol 2%, sodium dodecyl benzene sulfonate 4% (humectant), sodium lignin sulfonate 10% (dispersant), ammonium sulfate 3% (disintegrant), kaolin (filler) of the complement to 100%.

### Formulation Example 10

### 50% Fluazinam•Eugenol Water Dispersible Granules

Fluazinam 45%, eugenol 5%, sodium dodecyl benzene sulfonate 4% (humectant), sodium lignin sulfonate 10% (dispersant), ammonium sulfate 3% (disintegrant), kaolin (filler) of the complement to 100%.

Examples of Wettable Powder

The active ingredients of pesticides, additives, fillers are mixed in given proportion and are crushed by the jet mill, then admixed to obtain a wettable powder. Major equipments: mixer, jet mill.

### Formulation Example 11

### 30% Fluazinam•Eugenol Wettable Powder

Fluazinam 18%, eugenol 12%, sodium lauryl alcohol 4% (humectant), sodium alkyl sulfonate 7% (dispersant), white carbon black 8% (filler), kaolin (filler) of the complement to 100%.

### Formulation Example 12

### 40% Fluazinam•Eugenol Wettable Powder

Fluazinam 39.5%, eugenol 0.5%, sodium lauryl alcohol 4% (humectant), sodium alkyl sulfonate 7% (dispersant), white carbon black 8% (filler), kaolin (filler) of the complement to 100%.

### Formulation Example 13

### 25% Fluazinam•Eugenol Wettable Powder

Fluazinam 20%, eugenol 5%, sodium lauryl alcohol 4% (humectant), sodium alkyl sulfonate 7% (dispersant), white carbon black 8% (filler), kaolin (filler) of the complement to 100%.

### Field Application Example 1

### Field Efficacy Experiments of Fluazinam Synergized with Eugenol to the Pepper Phytophthora Blight

Test site is Haikou in Hainan. Table 3 shows test pesticides and dosages thereof. Four plots are treated per pesticide and replicates. Each plot has surface area of 20 square meters. The pesticides are applied in the early occurrence of disease and are uniformly sprayed onto the leaves until dripping for the first time. Clean water is used as the blank control. Seven days later, the pesticides are applied for the second time. Disease incidence of the pepper phytophthora blights to the peppers prior to the first pesticide application and that of after 15 days from the second pesticide application are surveyed. Each plot uses a five-point sampling means, surveying two per point, and recording the number of diseased plants, dead plants and apparent withered plants. Disease index and control effect are calculated for each treatment.

Classification criteria:

Classification method (according to symptom types):

0 level: health, no disease;

1 level: lesions happen only to overground leaves and fruitst;

3 level: brown rot spots happen to overground stems and branches;

5 level: brown rot spots happen to the stem base;

7 level: brown rot spots happen to overground stems, branches and stem base, and some dead branches;

9 level: entire plant dead.

Efficacy calculation method:

Disease index=[Σ(plant quantity in each level×respective level number)×100]/(Total quantity of tested plants×9).

Control effect (%)=[1−(disease index of blank plot before treatment×disease index of tested plot after treatment)/(disease index of blank plot after treatment×disease index of tested plot before treatment)]×100.

It can be seen from Table 3 that the control effects of separated pesticides of fluazinam and eugenol to the pepper blight are respectively 78.7% and 71.6%, and the control effect of the pesticide composition of the embodiment of the present invention is significantly improved, minimum control efficiency of 85.6%, the highest up to 93.0%. Field experiment results substantially demonstrates that fluazinam synergized with eugenol has a significant synergistic action to the pepper blight, and has a substantial increase in the control effect even if amount of active ingredients per acre is less than that of a single pesticide. Accordingly, the composition of the present invention has beneficial effects of reduced cost, delay resistance, reduced frequency of pesticide application and reduced pesticide residues.

TABLE 3
Field experiment results of fluazinam synergized with eugenol to the pepper blight

| | | | Disease indexes | |
|---|---|---|---|---|
| | Pesticide | | after 7 days from | Control |
| | dosages | Disease indexes | the second pesti- | effects |
| Pesticides to be tested | (g · a.i./ha) | before treatment | cide application | (%) |
| 50% Fluazinam | 250 | 2.5 | 8.9 | 78.7 |
| suspension | | | | |
| 0.3% Eugenol soluble | 20 | 3.0 | 12.7 | 71.6 |
| liquid agent | | | | |
| Formulation Example 1 | 15 | 2.8 | 5.1 | 87.8 |
| (15.3% Fluazinam•Eugenol | | | | |
| suspension) | | | | |
| Formulation Example 2 | 18 | 3.5 | 7.5 | 85.6 |
| (30.3% Fluazinam•Eugenol | | | | |
| suspension) | | | | |
| Formulation Example 4 | 18 | 2.7 | 4.3 | 89.3 |
| (21% Fluazinam•Eugenol | | | | |
| suspension) | | | | |
| Formulation Example 5 | 15 | 3.3 | 4.7 | 90.4 |
| (6.2% Fluazinam•Eugenol | | | | |
| suspension) | | | | |
| Formulation Example 7 | 16 | 2.9 | 5.5 | 87.3 |
| (5% Fluazinam•Eugenol | | | | |
| aqueous emulsion) | | | | |
| Formulation Example 9 | 16 | 2.5 | 2.6 | 93.0 |
| (80% Fluazinam•Eugenol | | | | |
| water dispersible granule) | | | | |
| Formulation Example 12 | 18 | 3.7 | 5.1 | 90.7 |
| (40% Fluazinam•Eugenol | | | | |
| wettable powder) | | | | |
| CK | — | 3.1 | 46.2 | — |

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

1. A bactericidal composition containing fluazinam, comprising:
effective ingredients of fluazinam and eugenol, a weight ratio of fluazinam to eugenol being from 1:50 to 100:1.

2. The bactericidal composition according to claim 1, wherein the weight ratio of fluazinam to eugenol is from 1:30 to 20:1.

3. The bactericidal composition according to claim 1, wherein total weight percentage of fluazinam and eugenol of the composition is from 5% to 80%.

4. The bactericidal composition according to claim 1, wherein the composition further comprises assistants and fillers used in the processing of the active ingredients.

5. The bactericidal composition according to claim 4, wherein formulation type of the composition is aqueous emulsion type.

6. The bactericidal composition according to claim 4, wherein the assistants comprises: organic solvent, emulsifier, antifreezer, and humectant.

7. The bactericidal composition according to claim 6, wherein the organic solvent is selected from the group consisting of: isopropanol, dimethylbenzene, N,N-dimethyl formamide, cyclohexanone, methylbenzene, dimethyl sulfoxide, methanol, alcohol, trimethyl-2-cyclohexen-1-one, N-octyl pyrrolidone, N-methyl pyrrolidone, propanol, butanol, ethanediol, diethylene glycol, ethylene glycol methyl ether, butylether, acetic ether and vegetable oil.

8. The bactericidal composition according to claim 6, wherein the dispersant is selected from the group consisting of: sodium lignosulphonate, calcium lignosulphonate, nekal, calcium dodecylbenzene sulfonate, polycarboxylate, calcium alkylaromatic sulfonate, alkylphenol ethoxylates, aliphatic amine polyoxyethylene ether, polyoxyethylene fatty acid ester and glycerin fatty acid ester ethoxylates.

9. The bactericidal composition according to claim 6, wherein the emulsifier is selected from the group consisting of: phenyl phenol polyoxyethylene ether, phenylethyl phenol polyoxyethylene polypropylene ether, calcium alkylbenzene sulfonate, OP series phosphate, phenyl phenol polyoxyethylene ether phosphate, styrene polyoxyethylene ether ammonium sulfate, magnesium alkyl diphenyl ether disulfonate, triethanolamine salt, phenyl dimethylphenol polyoxyethylene ether, alkyl phenolic resin polyoxyethylene ether, phenylethyl phenol formaldehyde resin polyoxyethylene ether, phenylethyl phenol polyoxyethylene polypropylene ether, epoxyethane propylene oxide block copolymer, polyoxyethylene nonyl phenol ether, alkylaryl polyoxypropylene polyoxyethylene ether, alkylaryl polyoxyethylene polyoxypropylene ether, sorbitan monostearates, polyoxyethylene sorbitan fatty acid esters and fatty alcohol polyoxyethylene ether.

10. The bactericidal composition according to claim 6, wherein the antifreezer is selected from the group consisting of: propanetriol, carbamide, ethanediol and propanediol.

11. The bactericidal composition according to claim 6, wherein the humectant is selected from the group consisting of: sodium naphthalenesulfonate formaldehyde condensates, sodium dodecyl sulfate, sodium alkylnaphthalene sulphonate, calcium alkylbenzene sulfonate, sasangua cake, shikakai powder, silkworm excrement, sapindus power, sodium lauryl sulfate, washing powder and nekal powder.

12. The bactericidal composition according to claim 6, wherein the disintegrating agent is selected from the group consisting of: ammonia sulfate, carbamide, bentonite, aluminium chloride, citric acid, succinic acid and sodium bicarbonate.

13. The bactericidal composition according to claim 6, wherein the thickener is selected from the group consisting of: xanthan gum, hydroxy methyl cellulose, methylcellulose, magnesium aluminum silicate and polyvinyl alcohol.

14. The bactericidal composition according to claim 4, wherein the filler is selected from the group consisting of: white carbon black, clay, light calcium carbonate, speckstone, montmorillonite, palygorskite, pumice, brickbat, sepiolite, bentonite, non-adsorptive calcareous soil and sand.

15. An application of the bactericidal composition according to claim 1 is to prevent and cure a pepper phytophthora blight. A method for manufacturing gallium nitride-based film chip, the method comprising: [symbol]
